(19) United States
(12) Patent Application Publication
(10) Pub. No.: US 2025/0380115 A1
(43) Pub. Date: Dec. 11, 2025

(54) DYNAMIC VERIFICATION OF SUBSCRIBER REQUESTS VIA USSD SESSIONS

(71) Applicant: T-MOBILE INNOVATIONS LLC, Overland Park, KS (US)

(72) Inventors: Phani RAMISETTY, Sammamish, WA (US); Shewangizaw Workineh Gebremariam, Edmonds, WA (US)

(21) Appl. No.: 18/734,297

(22) Filed: Jun. 5, 2024

(51) Int. Cl. H04W 4/14; H04W 8/18

(52) U.S. Cl. CPC H04W 4/14; H04W 8/18

(57) ABSTRACT

Systems and methods are provided for improved use of unstructured supplementary service data (USSD) by subscribers. A subscriber request via USSD is received. A verification message is sent to the subscriber. A subscriber response to the verification message is received. Whether the subscriber request is verified is determined based on the subscriber response. The subscriber request may be approved or terminated based on the determination. In verifying a subscriber USSD request by determining whether the subscriber response is verified prior to fulfillment of the subscriber request, a more secure network environment may result.

### SUMMARY

The present disclosure is directed, in part to verifying a subscriber request for information and/or services via an unstructured supplementary service data (USSD) session, substantially as shown and/or described in connection with at least one of the figures, and as set forth more completely in the claims.

According to various aspects of the technology, USSD provides real-time communication between user equipment (UE) and various application servers within a core network. Subscribers can enter short codes corresponding to specified requests for information and/or services provided via USSD sessions, such as to check an account balance or to set up call- and/or text-forwarding. However, scammers have developed schemes to manipulate USSD protocols and sessions to fraudulently access the personal information of subscribers, often by phishing links that enable the scammer to quietly set up call- and/or text-forwarding via USSD from the subscriber’s UE to the scammer’s own device. Conventional frameworks primarily focus on reactive solutions and fail to provide a robust, proactive approach that prevents fraudulent USSD requests from proceeding to fulfillment. The present disclosure provides a proactive approach to verify whether a particular subscriber request via USSD genuinely originates from the subscriber or from a scammer before allowing the subscriber request to proceed to fulfillment.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

FIG. 1 illustrates an exemplary computing device for use with the present disclosure;

FIG. 2 illustrates a diagram of an exemplary network environment in which implementations of the present disclosure may be employed;

FIG. 3 illustrates a flow diagram of an exemplary method for verifying a subscriber request via unstructured supplementary service data (USSD) in which implementations of the present disclosure may be employed;

FIG. 4 illustrates a flow diagram of an exemplary method for verifying a subscriber request via USSD in which implementations of the present disclosure may be employed;

FIG. 5 illustrates a flow diagram of an exemplary method for verifying a subscriber request via USSD in which implementations of the present disclosure may be employed; and

FIG. 6 illustrates a flow diagram of an exemplary method for verifying a subscriber request via USSD in which implementations of the present disclosure may be employed.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include Global System for Mobile Communications (GSM), 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions – including data structures and program modules – in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, unstructured supplementary service data (USSD) is a communication protocol enabling a session-based, real-time communication between eligible user equipment (UE) and application servers. Communications via USSD do not require a device be a smartphone or be connected to the internet, and as a result, USSD is an accessible communication platform. Because communications via USSD are session-based and in real-time, responses from service providers are near instant. USSD is a premier choice of communication where real-time, immediate answers to subscriber requests are warranted. However, scammers have developed schemes to access the personal information of subscribers, often by sending phishing links that, when opened, allow the scammer to access the call dialer of subscriber UEs and submit requests to the USSD gateway as if the scammer were the subscriber. After opening the phishing link, the scammer can manipulate the subscriber’s call dialer to enter well-known short USSD codes to request call- and text-forwarding services in order to receive a subscriber’s personal information (e.g., authentication messages, verification messages, etc.) to the scammer’s own device. The scammer may then intercept such personal information to access a subscriber’s personal banking, social media, email accounts, or more.

Conventionally, subscribers affected by these scams are left with reactive solutions that seek to prevent further harm from fraudulent USSD requests, rather than proactive solutions that prevent scammer access to the USSD gateway such as to avoid the fraudulent USSD request from proceeding to completion. Such solutions include USSD traffic monitoring and end-to-end encryption of USSD response messages. Other solutions, such as access control based on subscriber credentials and/or device identifiers are insufficient to prevent scammer access to the subscriber’s own device. These solutions do not prevent a scammer from completing a fraudulent USSD request (e.g., setting up call- or text-forwarding via USSD) on a subscriber’s own device, as each seeks to prevent the scammer’s access to or understanding of USSD messages or responses to such requests.

In contrast to conventional solutions and to facilitate a more optimized use of USSD protocols, the present disclosure is directed to a proactive systems and methods that prevent a scammer from successfully completing a USSD request via the subscriber’s call dialer, even after a subscriber clicks a phishing link, for example. Under this proactive framework, a USSD gateway (or a network component in communication with the USSD gateway), in response to receiving a subscriber request via USSD, transmits a verification message to the subscriber. In response, the subscriber submits a subscriber response to the verification message. The USSD gateway then determines, based on the subscriber response, whether the subscriber request is verified (e.g., whether the subscriber request was genuinely requested by the subscriber rather than a scammer). Based on this determination, the USSD gateway can then determine whether to approve or terminate the subscriber request. Providing a proactive solution to such an insidious problem allows for both front-end and back-end control of the USSD gateway, rather than the primarily back-end protection provided by existing solutions.

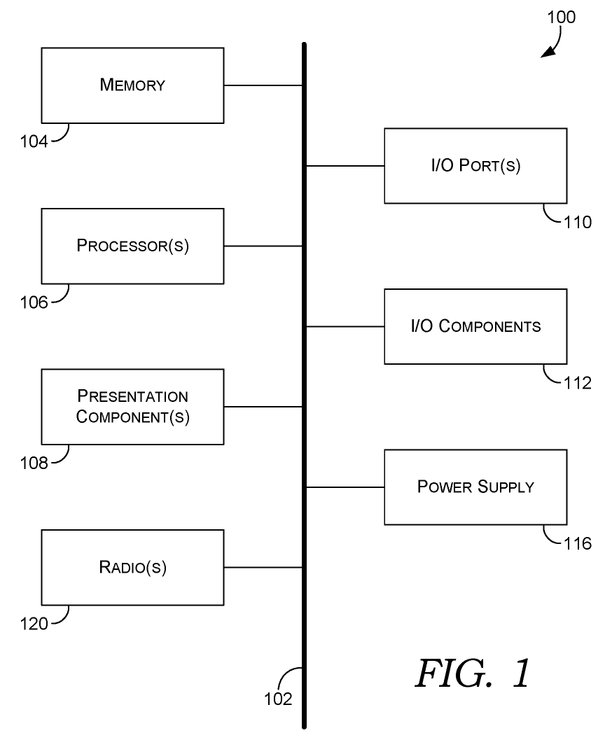

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the present disclosure. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment (UE), wireless communication device, or user device. The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like, which are configured to access information and/or services via USSD and/or communicate with a component configured to access information and/or service via USSD.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

The radio 120 represents one or more radios that facilitate communication with one or more wireless networks using one or more wireless links. While a single radio 120 is shown in FIG. 1, it is expressly contemplated that there may be more than one radio 120 coupled to the bus 102. In aspects, the radio 120 utilizes a transmitter to communicate with a wireless telecommunications network. It is expressly contemplated that a computing device 100 with more than one radio 120 could facilitate communication with the wireless network via both the first transmitter and additional transmitters (e.g. a second transmitter). Illustrative wireless telecommunications technologies include CDMA, GPRS, TDMA, GSM, and the like. The radio 120 may carry wireless communication functions or operations using any number of desirable wireless communication protocols, including USSD, 802.11 (Wi-Fi), WiMAX, LTE, 3G, 4G, LTE, 5G, NR, 6G, VoLTE, or other VoIP communications. As can be appreciated, in various embodiments, radio 120 can be configured to support multiple technologies and/or multiple radios can be utilized to support multiple technologies. A wireless telecommunications network might include an array of devices, which are not shown as to obscure more relevant aspects of the invention. Components such as a base station or communications tower (as well as other components) can provide wireless connectivity in some embodiments.

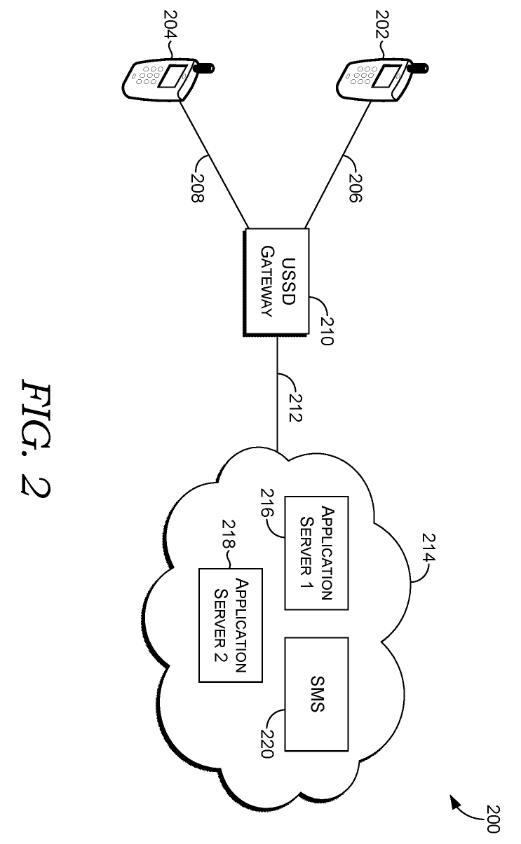

Referring now to FIG. 2, an exemplary network environment is illustrated in which implementations of the present disclosure may be employed. Such a network environment is illustrated and designated generally as network environment 200. Network environment 200 is but one example of a suitable network environment and is not intended to suggest any limitation as to the scope or use or functionality of the present disclosure. Neither should the network environment be interpreted as having any dependency or requirement relating to any one or combination of components illustrated.

Network environment 200 represents a high level and simplified view of relevant portions of a modern wireless telecommunication network. At a high level, the network environment 200 may generally be said to comprise one or more UEs, such as a first UE 202 and/or a second UE 204, one or more USSD gateways, such as USSD gateway 210, a core network 214 including at least a first application server 216 and/or a second application server 218, and an SMS network component 220, though in some implementations, it may not be necessary for certain features to be present. For example, in some aspects, the network environment 200 may not comprise the second UE 204 and/or may comprise more than one USSD gateway 210. The network environment may include a number of base stations, routers, switches, and the like. The network environment 200 is generally configured for wirelessly connecting the first UE 202 and/or the second UE 204 to data or services that may be accessible on one or more application servers or other functions, nodes, or servers not pictured in FIG. 2 so as to not obscure the focus on the present disclosure. Though shown as disposed within the core network 214, it is expressly contemplated that the location illustrated in the network environment 200 is non-limiting. For example, the first application server 216 and/or the second application server 218 may be disposed between the USSD gateway 210 and the core network 214 (i.e., network edge) or may be isolated as stand-alone components.

The network environment 200 comprises one or more of the first UE 202 and/or the second UE 204. The first UE 202 and the second UE 204 are illustrated generally, and may take any number of forms, including a tablet, phone, or wearable device, or any other device discussed with respect to FIG. 1 and may have any one or more components or features of the computing device 100 of FIG. 1. In some aspects, the first UE 202 and/or the second UE 204 may not be a conventional telecommunications devices (i.e., a device that is capable of placing and receiving voice calls), but may instead take the form of devices that only utilizes wireless network resources in order to transmit or receive data; such devices may include IoT devices configured to access information and/or services via USSD (e.g., smart appliances, thermostats, locks, smart speakers, lighting devices, smart receptacles, and the like). In aspects, the first UE 202 and/or the second UE 204 may be associated with a subscriber of information and/or services.

The network environment 200 comprises one or more of the USSD gateway 210 with which the first UE 202 and/or the second UE 204 may potentially communicate. Though network environment 200 is illustrated with a single USSD gateway 210, one skilled in the art will appreciate that additional USSD gateways may be present in any particular network environment. The USSD gateway 210 is configured to wirelessly communicate with UEs, such as the first UE 202 and/or the second UE 204. The USSD gateway 210 may communicate with one or more of the first UE 202 and/or the second UE 204 via USSD protocols within various wireless networks (e.g., GSM, CDMA, LTE, 3G, 4G, 5G, 6G). The USSD gateway 210 may, alone and/or in combination with other components of the network environment 200, verify a subscriber request originating from a UE, such as the first UE 202 and/or the second UE 204.

The USSD gateway 210 is configured to receive one or more of a first signal 206 and/or a second signal 208 between the USSD gateway 210 and the first UE 202 and/or between the USSD gateway 210 and the second UE 204. The first signal 206 and/or the second signal 208 may represent one or more subscriber requests from the first UE 202 to the USSD gateway 210 and/or from the second UE 204 to the USSD gateway 210. In response to receiving subscriber requests from the first UE 202 and/or the second UE 204, the USSD gateway 210 may communicate with the core network 214 via a backhaul 212. While base stations are not shown in FIG. 2 for brevity, one or more base stations may facilitate the mutual communication between the first UE 202 and the USSD gateway 210, the second UE 204 and the USSD gateway 210, and/or the USSD gateway 210 and the core network 214.

The SMS network component 220 is configured to communicate with the subscriber (such as via the first UE 202 and/or the second UE 204) and/or the USSD gateway 210. The SMS network component 220, while designated as an SMS network component 220, may take the form of a multimedia messaging service (MMS) network component. The SMS network component 220 may be one or more components of SMS infrastructure (e.g., SMS center) and/or one or more components of MMS infrastructure. In some embodiments of the present disclosure, the SMS network component 220 may send or transmit a verification message to determine whether the subscriber request is verified (i.e., was genuinely requested by the subscriber rather than a scammer), and in other embodiments, the USSD gateway 210 may send or transmit a verification message to determine whether the subscriber request is verified. In some embodiments, the SMS network component 220 may receive a subscriber response to the verification message.

The subscriber request sent via USSD may be generated by the subscriber entering a short code into a call dialer of the subscriber’s UE, such as the first UE 202 and/or the second UE 204. The subscriber may enter a short code into the call dialer, which may include the entry of various numbers, letter, symbols (e.g., #, *, %), or a combination of these. This short code defines a particular subscriber request to access or request particular services and/or information be provided to the subscriber, and upon the subscriber entering the short code and/or upon the subscriber pressing a call or send button after entering the short code, the subscriber request is sent to the USSD gateway 210. The subscriber request may request information stored on an application server, and/or it may request an application server take an action and/or provide services requested by the subscriber request. In some aspects, the subscriber request is a request for call and/or text (e.g., SMS, MMS) forwarding. In other aspects, the subscriber request is a request for an account balance, a request to purchase additional resources from a service provider associated with the subscriber request, a request to subscribe to a service provided by the service provider, and the like.

The USSD gateway 210 may communicate with one or more application servers located within the core network 214, such as a first application server 216 and/or a second application server 218. The first application server 216 and/or the second application server 218 may receive subscriber requests from the USSD gateway 210 and/or perform subscriber requests, such as retrieving information from databases or external systems. The first application server 216 and/or the second application server 218 may be associated with one or more service providers (e.g., mobile services provider, prepaid mobile services provider, banking provider, utilities provider, healthcare provider). The first application server 216 and/or the second application server 218 may generate a reply to the USSD gateway 210 in response to the subscriber request transmitted by the USSD gateway 210. The first application server 216 and/or the second application server 218 may contain information relevant to the subscriber operating the UE, such as the first UE 202 and/or the second UE 204. The first application server 216 and/or the second application server 218 may, additionally or alternatively, be configured to perform one or more actions requested by the subscriber via the USSD gateway 210. For example, the first application server 216 may be configured to transact with the subscriber such as to allow the subscriber to purchase additional resources (e.g., data capacity, minutes) associated with the service corresponding to the first application server 216. In another example, the first application server 216 may store account information related to a banking service. The subscriber associated with the banking service may request an account balance via the USSD gateway 210, and the first application server 216 may respond to the USSD gateway 210 with the account balance, for example. In yet another example, the first application server 216 may be associated with a mobile services provider, and the subscriber request may comprise a request for call- and/or text-forwarding.

Relevant to the present disclosure, USSD short codes may be harnessed by scammers or cyber criminals to access or assert control over a subscriber’s UE, such as the first UE 202 and/or the second UE 204. A scammer may send a subscriber’s UE, such as the first UE 202 and/or the second UE 204, a malicious message containing a phishing link. This phishing link, when clicked by the subscriber, allows the scammer to manipulate the call dialer of the subscriber’s UE, such as the first UE 202 and/or the second UE 204. The scammer may then manipulate the call dialer to dial specified USSD codes associated with particular actions, service, and/or information. In some aspects, this may involve the scammer entering a short code associated with call- and/or text-forwarding with the inclusion of numbers or characters provided in the malicious message corresponding to the scammer’s own device. This process may take less than a few seconds, and the subscriber may be unaware that call- and/or text-forwarding has been established on the subscriber’s UE, such as the first UE 202 or the second UE 204, via USSD. Once call- and/or text-forwarding is established in favor of the scammer’s own device, the scammer can receive authentication information (e.g., codes, two-factor authentication, answer call to verify, forgot password links), which will be directly communicated to the scammer’s own device rather than that of the subscriber’s. In other aspects, fraudulent USSD requests may request subscription to or payment of services not requested by the subscriber, trigger the download of malicious software, disable security features of the subscriber’s UE, and the like.

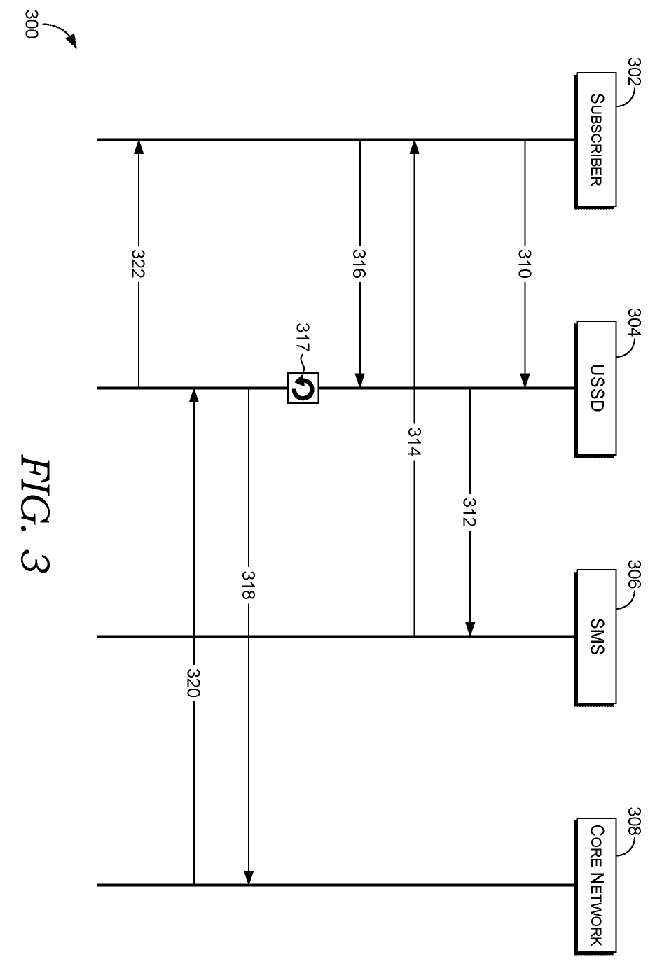

Turning now to FIG. 3, a call flow diagram is illustrated in accordance with one or more aspects of the present disclosure. A call flow 300 may be said to exist between one or more network components discussed in greater detail herein and is not meant to exhaustively show every interaction that would be necessary to practice the present disclosure, so as not to obscure the present disclosure, but is instead meant to illustrate one or more potential interactions between network components. The call flow 300 may be relevantly said to include a subscriber 302, a USSD gateway 304 (such as the USSD gateway 210 of FIG. 2), a SMS network component 306 (such as the SMS network component 220 of FIG. 2), and a core network 308 (such as the core network 214 of FIG. 2). Each of the preceding network components may take different forms, including consolidated or distributed forms that perform the same general operations.

FIG. 3 illustrates a number of interactions between network components during a subscriber request, such as a subscriber’s request for call- and/or text-forwarding. At a first step 310, the USSD gateway 304 receives a subscriber request via USSD. This may involve the subscriber 302 clicking a phishing link in a malicious message sent by a scammer. Then, once the subscriber 302 clicks the phishing link, the scammer may then manipulate the subscriber’s UE (such as the first UE 202 and/or the second UE 204 of FIG. 2) to enter a short code in the call dialer, creating a subscriber request for service and/or information (e.g., call- and/or text-forwarding). In other aspects, this may involve the subscriber 302 themselves entering the short code in the call dialer of the subscriber’s UE. However, the USSD gateway 304 is unaware whether the subscriber request truly originates from the subscriber 302 or a scammer seeking unauthorized access.

Relevant to the present disclosure, at a second step 312, the USSD gateway 304 requests a verification message be sent to the subscriber 302 via short messaging service (SMS). The USSD gateway 304 may communicate with the SMS network component 306, such as an SMS center, or it may communicate with another network component in communication with the SMS network component 306, to request a verification message be sent to the subscriber 302 via SMS. The verification message may comprise a question posed to the subscriber 302 asking whether the subscriber request (e.g., call- and/or text-forwarding) was genuinely requested by the subscriber 302 rather than a scammer or another unauthorized user. The verification message may specify one or more desired ways in which the subscriber 302 is expected to respond (e.g., enter “YES” to continue, respond with code 12345 to continue, enter “NO” to prohibit this action, click this link and/or button to continue, and the like). The verification message may specify the type of USSD service, information, and/or action requested in the subscriber request, the time at which the subscriber request(s) occurred, a warning to the subscriber 302 of the potential consequences of verifying the subscriber request, the number of times the requested USSD action of the subscriber request has been requested, and the like. The verification message may be displayed in any suitable messaging (e.g., SMS, MMS) platform associated with the subscriber’s UE.

At a third step 314, and in response to the USSD gateway 304 request for the SMS network component 306 to send the verification message to the subscriber 302, the subscriber 302 receives the verification message. The verification message may specify one or more desired ways in which the subscriber 302 is expected to respond (e.g., select “YES” to continue, respond with code 12345 to continue, enter “NO” to deny this action, click this link to continue, check this box to continue). The subscriber 302 may respond by entering (e.g., texting, typing, clicking, selecting) the subscriber response into the subscriber’s UE. For example, the subscriber response may be entered into a pop-up associated with USSD (despite the verification message being sent via SMS), or the subscriber may respond by entering the subscriber response into a SMS-based service platform, or a combination of these.

At a fourth step 316, the USSD gateway 304 receives the subscriber response to the verification message from the subscriber 302. The subscriber response may take a variety of forms, and the subscriber response may be in a format specified by the verification message. The subscriber response may comprise an alphabetical text string (e.g., “YES,” “NO”), an alphanumerical text string (e.g., “CA433Bf#”), a numerical text string (e.g., “12345”), an indication that the subscriber 302 clicked and/or selected a specified link or button, and/or a combination of these. As used herein “alphanumerical text string” may include one or more numbers, letters, and/or symbols that may be typed from a UE. In some aspects, the subscriber response is sent from the subscriber 302 to the USSD gateway 304 via USSD, such as via a pop-up and/or via the call dialer of the subscriber’s UE. In other aspects, the subscriber response is sent from the subscriber 302 to the SMS network component 306, via SMS, and then the SMS network component 306 communicates the subscriber response to the USSD gateway 304.

Once the USSD gateway 304 has received the subscriber response to the verification message, and in a fifth step 317, the USSD gateway 304 determines, based on the content of the subscriber response, whether the subscriber response is verified. The USSD gateway may generate, store, receive and/or transmit a verified response representing an expected response from the subscriber 302 had the subscriber request been verified by the subscriber 302. The verified response may comprise an alphabetical text string (e.g., “YES”) an alphanumerical text string (e.g., “CA433Bf#”), a numerical text string (e.g., “12345”), an indication that the subscriber 302 clicked and/or selected a specified link or button, or a combination of these. The USSD gateway may compare the subscriber response actually received from the subscriber with the expected verified response. When the USSD gateway 304 determines the received subscriber response does not match the expected verified response, the USSD gateway 304 determines the subscriber response is not verified. When the USSD gateway 304 determines the received subscriber response does match the expected verified response, the USSD gateway 304 determines the subscriber response is verified. In some aspects, the USSD gateway 304 may find the subscriber response is within a predetermined accuracy threshold such as to allow a subscriber request to continue proceeding despite the subscriber response deviating from the expected verified response.

At this point in the call flow 300, the USSD gateway 304 may determine the subscriber request is verified or the USSD gateway 304 may determine the subscriber request is not verified. In some aspects, when the USSD gateway 304 determines the subscriber request is not verified, the USSD gateway 304 may terminate the subscriber request, deny the subscriber request from continuing, and/or send an alert to a security team (e.g., internal, external) to take an action corresponding to the unverified USSD request. In other aspects, when the USSD gateway 304 determines the subscriber response is verified, the USSD gateway 304 approves the subscriber request to continue as requested. In such aspects in which the subscriber response is verified, at a sixth step 318, the USSD gateway 304 requests the core network 308 (such as the core network 214 of FIG. 2) provide information and/or services in response to the subscriber request. The core network 308 may include application servers (such as the first application server 216 and/or the second application server 218 of FIG. 2) containing information relevant to the subscriber 302 and/or configured to perform actions requested by the subscriber 302 in the subscriber request.

In aspects in which the subscriber response is verified, and in a seventh step 320, the USSD gateway 304 receives a fulfilled subscriber response (i.e., a response from the core network 308 fulfilling that requested in the subscriber request) from the core network 308. The fulfilled subscriber response may include information relevant to the subscriber 302, such as account balance information, data use information, remaining minutes, and the like. The fulfilled subscriber response may additionally or alternatively include one or more confirmation messages confirming the core network 308 (such as application servers within the core network 308) has performed the actions requested in the subscriber request. In an eighth step 322, the USSD gateway 304 transmits the fulfilled subscriber response to the subscriber 302. The fulfilled subscriber response may be displayed on one or more graphical interfaces associated with the UE of the subscriber 302 (e.g., within an SMS platform, within a USSD pop-up).

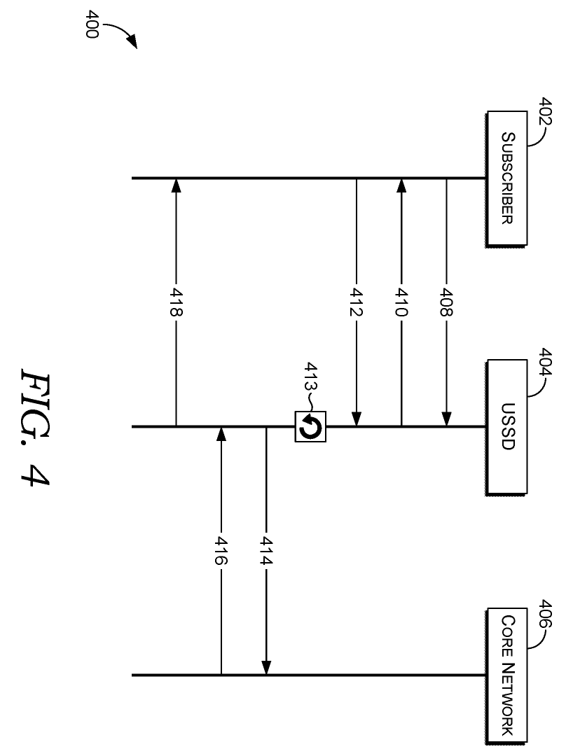

Turning now to FIG. 4, a call flow diagram is illustrated in accordance with one or more aspects of the present disclosure. A call flow 400 may be said to exist between one or more network components discussed in greater detail herein and is not meant to exhaustively show every interaction that would be necessary to practice the present disclosure, so as not to obscure the present disclosure, but is instead meant to illustrate one or more potential interactions between network components. The call flow 400 may be relevantly said to include a subscriber 402 (such as the subscriber 302 of FIG. 3), a USSD gateway 404 (such as the USSD gateway 210 of FIG. 2 and/or the USSD gateway 304 of FIG. 3), and a core network 406 (such as the core network 214 of FIG. 2 and/or the core network 308 of FIG. 3). Each of the preceding network components may take different forms, including consolidated or distributed forms that perform the same general operations. In contrast to FIG. 3, the call flow 400 of FIG. 4 does not require a SMS network component (such as the SMS network component 220 of FIG. 2 and/or the SMS network component 306 of FIG. 3) send the verification message to the subscriber 402. However, in some embodiments illustrated by FIG. 4, a SMS network component may be involved in other steps of the call flow 400, as will be apparent from the following discussion.

FIG. 4 illustrates a number of interactions between network components during a subscriber request, such as a subscriber’s request for call- and/or text-forwarding. At a first step 408, the USSD gateway 404 receives a subscriber request via USSD. In some aspects, the subscriber request may not be genuinely requested by the subscriber and instead may be requested by a scammer. In other aspects, the subscriber 402 themselves has entered the short code in the call dialer of the subscriber’s UE (such as the first UE 202 and/or the second UE 204 of FIG. 2). However, the USSD gateway 404 is unaware whether the subscriber request truly originates from the subscriber 402 or a scammer.

Relevant to the present disclosure, at a second step 410, the USSD gateway 404 sends and/or transmits a verification message to the subscriber 402 via USSD. The verification message may comprise a question posed to the subscriber 402 asking whether the subscriber request (e.g., call- and/or text-forwarding) was genuinely requested by the subscriber 402 rather than by a scammer. The verification message may specify one or more desired ways in which the subscriber 402 is expected to respond (e.g., select “YES” to continue, respond with code 12345 to continue, enter “NO” to deny this action, click this link to continue, check this box to continue). The verification message may specify the type of USSD service, information, and/or action requested by the subscriber request, the time at which the subscriber request(s) occurred, a warning to the subscriber 402 of the potential consequences of verifying the subscriber request, the number of times the requested USSD action of the subscriber request has been requested, and the like. The verification message may be displayed on the subscriber’s 402 UE, such as in a USSD pop-up window and/or at the call dialer of the subscriber’s 402 UE.

At a third step 412, the USSD gateway 404 receives the subscriber response to the verification message from the subscriber 402. The subscriber 402 may respond to the verification message by texting, typing, selecting, and/or clicking the subscriber response into the subscriber’s UE, such as within a pop-up associated with USSD or within the call dialer of the subscriber’s 402 UE. The subscriber response may take a variety of forms, and the subscriber response may be in a format specified by the verification message. The subscriber response may comprise an alphabetical text string (e.g., “YES,” “NO”), an alphanumerical text string (e.g., “CA433Bf#”), a numerical text string (e.g., “12345”), an indication that the subscriber clicked and/or selected a specified link or button, and/or a combination of these. In some aspects, the subscriber response is sent from the subscriber 402 to the USSD gateway 404 via USSD, such as via the subscriber’s UE call dialer and/or a pop-up associated with USSD. In other aspects, the subscriber response is sent from the subscriber 402 to the USSD gateway 404 via SMS (despite the verification message being sent via USSD), such as by the subscriber 402 sending the subscriber response to a SMS network component (such as the SMS network component 306 of FIG. 3), the SMS network component then communicating the subscriber response to the USSD gateway 404.

Once the USSD gateway 404 has received the subscriber response to the verification message, and in a fourth step 413, the USSD gateway 404 may determine, based on the content of the subscriber response, whether the subscriber response is verified. The USSD gateway may generate, store, receive and/or transmit a verified response representing an expected response from the subscriber 402 had the subscriber request been verified by the subscriber. The verified response may comprise an alphabetical text string (e.g., “YES”) an alphanumerical text string (e.g., “CA433Bf#”), a numerical text string (e.g., “12345”), an indication that the subscriber clicked and/or selected a specified link or button, or a combination of these. The USSD gateway 404 may compare the received subscriber response with the expected verified response. When the USSD gateway 404 determines the received subscriber response does not match the expected verified response, the USSD gateway 404 determines the subscriber request is not verified. When the USSD gateway 404 determines the received subscriber response does match the expected verified response, the USSD gateway 404 determines the subscriber response is verified. In some aspects, the USSD gateway 404 may find the subscriber response is within a predetermined accuracy threshold such as to allow a subscriber request to continue proceeding despite the subscriber response deviating from the expected verified response.

At this point in the call flow 400, the USSD gateway 404 may determine the subscriber request is verified or the USSD gateway 404 may determine the subscriber request is not verified. In some aspects, when the USSD gateway 404 determines the subscriber request is not verified, the USSD gateway 404 terminates the subscriber request, denies the subscriber request from continuing, and/or sends an alert to a security team (e.g., internal, external) to take an action associated with the fraudulent USSD request. In other aspects, when the USSD gateway 404 determines the subscriber response is verified, the USSD gateway 404 approves the subscriber request to continue as requested. In such aspects in which the subscriber response is verified, at a fifth step 414, the USSD gateway 404 requests the core network 406 (such as the core network 214 of FIG. 2 or the core network 308 of FIG. 3) provide information and/or services in response to the subscriber request. The core network 406 may include application servers (such as the first application server 216 and/or the second application server 218 of FIG. 2) containing information relevant to the subscriber 402 and/or configured to perform actions requested by the subscriber 402 in the subscriber request.

In aspects in which the subscriber response is verified, in a sixth step 416, the USSD gateway 404 receives a fulfilled subscriber response (i.e., a response from the core network 406 fulfilling that which was requested by the subscriber request). The fulfilled subscriber response may include information relevant to the subscriber 402, such as account balance information, data use information, remaining minutes, and the like. The fulfilled subscriber response may additionally or alternatively include one or more confirmation messages confirming the core network 406 (such as application servers within the core network 406) has performed the actions requested by the subscriber request. In a seventh step 418, the USSD gateway 404 transmits the fulfilled subscriber response to the subscriber 402. The fulfilled subscriber response may be displayed on one or more graphical interfaces associated with the UE of the subscriber 402 (e.g., within an SMS platform, within a USSD pop-up).

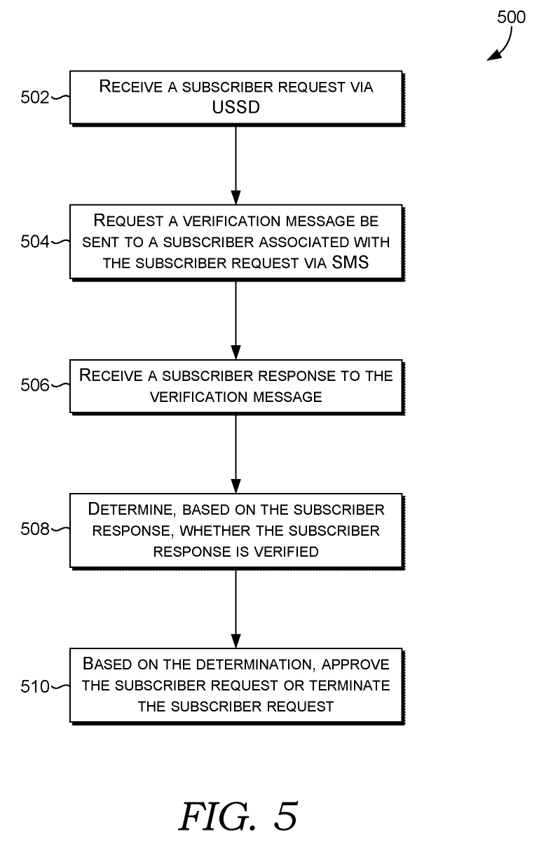

Turning now to FIG. 5, a flow chart is provided that illustrates one or more aspects of the present disclosure relating to a method 500 for verifying a subscriber request via USSD. In a first step 502, the USSD gateway (such as the USSD gateway 210 of FIG. 2, the USSD gateway 304 of FIG. 3, and/or the USSD gateway 404 of FIG. 4) receives a subscriber request via USSD. As one example, a subscriber associated with the subscriber request (such as the subscriber 302 of FIG. 3 and/or the subscriber 402 of FIG. 4) may wish to check their data balance of their mobile services provider account via USSD, and dials in a short code associated with checking an amount of data available for subscriber use. In a second step 504, and in response to receiving the subscriber request, the USSD gateway requests a verification message be sent to the subscriber associated with the subscriber request via SMS. This may involve the USSD gateway communicating with a SMS network component (such as the SMS network component 306 of FIG. 3) to request the SMS network component send the verification message to the subscriber.

In a third step 506, the USSD gateway receives a subscriber response to the verification message. The subscriber response may take a variety of forms, and may comply with a format designated in the verification message. In some aspects, the subscriber response may be sent via SMS from the subscriber to the SMS network component (such as the SMS network component 220 of FIG. 2, the SMS network component 306 of FIG. 3), and from the SMS network component to the USSD gateway. In other aspects, the subscriber response is sent via USSD (despite the verification message being sent via SMS), such as in a USSD pop-up on the subscriber’s UE (such as the first UE 202 or the second UE 204 of FIG. 2) and/or in the call dialer of the subscriber’s UE.

In a fourth step 508, the USSD gateway determines, based on the subscriber response, whether the subscriber response is verified. The USSD gateway may store, receive, and/or transmit a verified response representing an expected subscriber response had the subscriber request been genuinely and/or validly requested by the subscriber, rather than a scammer or cybercriminal. Where the subscriber response matches the verified response (or is within the predefined accuracy threshold of the verified response), the USSD gateway will determine the subscriber response is verified. When the subscriber response does not match the verified response, the USSD gateway will determine the subscriber response is not verified. In a fifth step 510, the USSD gateway, based on the determination made in the fourth step 508, approves the subscriber request or terminates the subscriber request. In some aspects, when the USSD gateway has determined the subscriber response is verified, the USSD gateway will approve the subscriber request such as to allow the subscriber request to be fulfilled as requested. In other aspects, when the USSD gateway has determined the subscriber response is not verified, the USSD gateway will deny and/or terminate the subscriber request such as to prevent the subscriber request from proceeding to fulfillment.

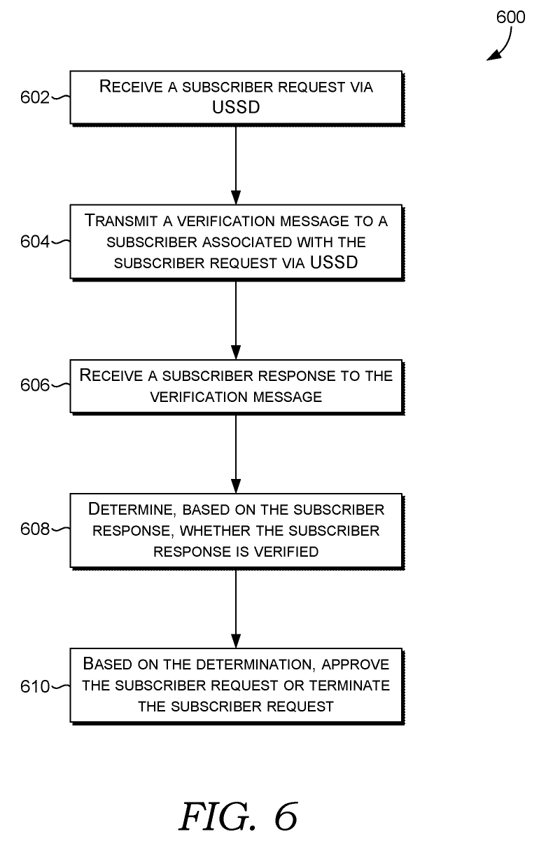

Turning now to FIG. 6, a flow chart is provided that illustrates one or more aspects of the present disclosure relating to a method 600 for verifying a subscriber request via USSD. In contrast to FIG. 5, the method 600 of FIG. 6 does not require an SMS network component (such as the SMS network component 220 in FIG. 2 and/or the SMS network component 306 in FIG. 3) send the verification message. In a first step 602, a USSD gateway (such as the USSD gateway 210 of FIG. 2, the USSD gateway 304 of FIG. 3, and/or the USSD gateway 404 of FIG. 4) receives a subscriber request via USSD. This may involve a subscriber (such as the subscriber 302 of FIG. 3 and/or subscriber 402 of FIG. 4) entering a short code associated with the desired subscriber request or a scammer manipulating the subscriber’s call dialer to enter the short code. In a second step 604, the USSD gateway transmits and/or sends a verification message via USSD to the subscriber associated with the subscriber request. The verification message may be displayed on the subscriber’s UE, such as in a USSD pop-up, and/or in the call dialer.

In a third step 606, the USSD gateway receives a subscriber response to the verification message. The subscriber response may take a variety of forms, and may comply with a format designated in the verification message. In some aspects, the subscriber response may be sent to the USSD gateway via USSD, such as in a USSD pop-up and/or in the call dialer. In other aspects, the subscriber response may be sent to the USSD gateway via SMS (despite the verification message being sent via USSD) such as via a SMS network component (such as the SMS network component 306 of FIG. 3).

In a fourth step 608, the USSD gateway determines, based on the subscriber response, whether the subscriber response is verified. The USSD gateway may store, receive, and/or transmit a verified response representing an expected subscriber response had the subscriber request been genuinely and/or validly requested by the subscriber, rather than a scammer or cybercriminal. Where the subscriber response matches the verified response (or is within the predefined accuracy threshold of the verified response), the USSD gateway will determine the subscriber response is verified. When the subscriber response does not match the verified response, the USSD gateway will determine the subscriber response is not verified. In a fifth step 610, the USSD gateway, based on the determination made in the fourth step 608, approves the subscriber request or terminates the subscriber request. In some aspects, when the USSD gateway has determined the subscriber response is verified, the USSD gateway will approve the subscriber request such as to allow the subscriber request to be fulfilled as requested. In other aspects, when the USSD gateway has determined the subscriber response is not verified, the USSD gateway will deny and/or terminate the subscriber request such as to prevent the subscriber request from proceeding to fulfillment.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A method for verifying a subscriber request via unstructured supplementary service data (USSD), the method comprising:
receiving a subscriber request via USSD;
requesting a verification message be sent to a subscriber associated with the subscriber request via short messaging service (SMS);
receiving a subscriber response to the verification message;
determining, based on the subscriber response, whether the subscriber request is verified; and
based on the determining, approving the subscriber request or terminating the subscriber request.

2. The method of claim 1, wherein the subscriber request comprises a request for call-forwarding.

3. The method of claim 1, wherein the subscriber request comprises a request for SMS-forwarding.

4. The method of claim 1, wherein the subscriber response comprises one of: an alphabetical text string, an alphanumerical text string, or a numerical text string.

5. The method of claim 1, wherein determining whether the subscriber request is verified comprises comparing a verified response with the subscriber response.

6. The method of claim 1, wherein terminating the subscriber request further comprises triggering an alert to an internal security team requesting the internal security team take an action.

7. The method of claim 1, wherein approving the subscriber request further comprises sending a fulfilled subscriber response to the subscriber via USSD.

8. A method for verifying a subscriber request via unstructured supplementary service data (USSD), the method comprising:
receiving a subscriber request via USSD;
transmitting a verification message to a subscriber associated with the subscriber request via USSD;
receiving a subscriber response to the verification message via USSD;
determining, based on the subscriber response, whether the subscriber response is verified; and
based on the determining, approving the subscriber request or terminating the subscriber request.

9. The method of claim 8, wherein the subscriber request comprises a request for call-forwarding.

10. The method of claim 8, wherein the subscriber request comprises a request for SMS-forwarding.

11. The method of claim 8, wherein the subscriber response comprises one of: an alphabetical text string, an alphanumerical text string, or a numerical text string.

12. The method of claim 8, wherein determining whether the subscriber request is verified comprises comparing a verified response with the subscriber response.

13. The method of claim 8, wherein terminating the subscriber request further comprises triggering an alert to an internal security team to take an action.

14. The method of claim 8, wherein approving the subscriber request further comprises sending a fulfilled subscriber response to the subscriber via USSD.

15. A system for verifying a subscriber request via unstructured supplementary service data (USSD), the system comprising:
one or more computer processing components configured to execute operations comprising:
receiving a subscriber request via USSD;
transmitting a verification message to a subscriber associated with the subscriber request;
receiving a subscriber response to the verification message;
determining, based on the subscriber response, whether the subscriber response is verified; and
based on the determining, approving the subscriber request or terminating the subscriber request.

16. The system of claim 15, wherein transmitting the verification message is via a short messaging service (SMS).

17. The system of claim 15, wherein transmitting the verification message is via USSD.

18. The system of claim 15, wherein the subscriber request comprises a request for call-forwarding.

19. The system of claim 15, wherein the subscriber response comprises one of: an alphabetical text string, an alphanumerical text string, or a numerical text string.

20. The system of claim 15, determining whether the subscriber request is verified comprises comparing a verified response with the subscriber response.
